(19) United States
(12) Patent Application Publication
(10) Pub. No.: US 2006/0190357 A1
(43) Pub. Date: Aug. 24, 2006

(54) Method for displaying display information

(75) Inventors: Michael Fuchs, Herrsching (DE); Marek Machacek, Munich (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY UNITED KINGDOM LIMITED, Weybridge (GB)

(21) Appl. No.: 11/350,031

(22) Filed: Feb. 9, 2006

(30) Foreign Application Priority Data
Feb. 9, 2005 (EP) 05 002 719.2

(51) Int. Cl. G06Q 30/00

(52) U.S. Cl. 705/27; 705/26

(57) ABSTRACT

A method for displaying display information (DI) via a start up screen (StS) and/or via a shut down screen (ShS) of a display means (DM) of a customer device (CD) is provided wherein a step of providing primary information data (PID) is realized by said customer device (CD) by passively receiving said primary information data (PID) from an external data source (DS) outside said customer device (CD) and wherein a step (B) of generating secondary information data (SID) which is representative for the display information (DI) to be displayed is realized in said or internal of said customer device (CD) in an active manner.

The present invention relates to a method for displaying display information via a start up screen and/or via a shut down screen of a display means of a customer device. More particularly the present invention relates to a method for generating a dynamic start up screen and/or a dynamic shut down screen.

When an electronic customer device is started or powered up, certain initializing procedures are performed. The time period during which the initializing procedures are performed is called start up phase. During such a start up phase a normal operation of the electronic customer device is not possible. The same holds for the so-called shut down phase, during which the normal operation is terminated and the given electronic customer device is shut down and for instance set into a standby mode.

In order to inform the user or customer that the electronic customer device is working but still in a power up or shut down phase and not ready for user desired operation a start up screen or a shut down screen with respective display in-formation is optically represented via a given display means. Nowadays the period of time for starting up or shutting down the system of the electronic customer device is used in order to display some useful information to the user or the operating person.

It is an object of the present invention to provide a method for displaying such display information via a start up screen and/or via a shut down screen of a display means of an electronic customer device which is more flexible with respect to the information content of the display information to be displayed.

The object underlying the present invention is achieved by a method for displaying display information according to the features of independent claim 1. Preferred embodiments of the inventive method for displaying display information are within the scope of the dependent sub-claims. The object underlying the present invention is also achieved by an apparatus, by an electronic customer device, by a computer program product, by a computer readable storage medium, by a method for generating display information, by a system for generating display information, as well as by an electronic user device for generating display information according to the features of claims 17, 19, 20, 21, 22, 23, and 24 respectively.

According to the present invention, a method for displaying display information is provided. The method for displaying display information according to the present invention is in particular adapted in order to for display display information via a start up screen and/or via a shut down screen of a display means of an electronic customer device. The method for displaying display information according to the present invention comprises steps of (A) providing primary information data, of (B) generating from said primary information data, secondary information data which are one of descriptive and representative for said display information to be displayed, and of (C) displaying on a start up screen and/or on a shut down screen at least said display information as said secondary information data or as a derivative thereof, wherein said step (A) of providing said primary information data is realized by at least—in particular passively—receiving said primary information data by said electronic customer device from an external data source outside said electronic customer device and wherein said step (B) of generating said secondary information data and said said display information is—in particular actively—realized inside or internal of said given electronic customer device.

It is therefore a key idea of the present invention to provide the necessary primary information data with respect to the electronic customer device in a passive manner, i.e. by a pure receiving step passively realized by the customer device which is accompanied by a respective active transmission or pushing process of data from and by the data source on the other side. Another key aspect of the present invention is that after having received the primary information data the process of evaluating the amount of primary information data and therefore the process of rendering and generating secondary information data and thereby of rendering the display information to be displayed are realized in an active manner inside the customer device. This is in contrast to known methods of displaying display information via start up screens or via shut down screens. In the known cases, the primary information data remain outside the customer device where the primary information data are evaluated and the respective secondary information data and therefore the display information is rendered and where the display information is then subjected to a transmission process in order to provide the finalized display information to the customer device in order to have it displayed by means of a respective display means of the customer device.

The content which is transmitted or pushed in step (A) is preferably localized in or to a network where the respective content is transmitted or pushed.

Usage of different OSD engines from different customer divices—of e.g. different models, brands, user preferences etc.—may or will in general lead to different secondary information data, display information and therefore to different start up and/or shut down screens even if the transmitted and pushed primary information data are in part or in complete the same or are comparable with respect to each other.

Preferably, said step (A) of providing said primary information data may be realized by—in particular actively by said data source—transmitting or pushing said primary information data from said data source to said given electronic customer device.

Additionally or alternatively, a non-bidirectional—e.g. a uni-directional—communication channel is used in or for said step (A) of providing said primary information data according to a preferred embodiment of the method for displaying display information according to the present invention.

Said step (A) of providing said primary information data may additionally or alternatively be performed according to a preferred embodiment of the method for displaying display information according to the present invention in one or an arbitrary plurality of circumstances of the group consisting of:
in a stand by mode of said electronic customer device,
in a partial or complete wake up mode of said given electronic customer device,
at repeated instances of time,
at predetermined instances of time,
at periodical instances of time, and
overnight.

The respective communication channel in or for said step (A) of providing said primary information data may further additionally or alternatively be realized according to an advantageous embodiment of the method for displaying display information according to the present invention completely or in part by one or an arbitrary plurality of circumstances of the group consisting of:
terrestrially,
via cable,
via air or wirelessly,
via satellite,
via a network,
via a home network, and
via the internet.

Additionally or alternatively, according to a further preferred embodiment of the method for displaying display information according to the present invention said communication channel in or for said step (A) of providing said primary information data may be realized completely or in part by a analogue broadcasting service.

Further additionally or alternatively, according to a further advantageous embodiment of the method for displaying display information according to the present invention said communication channel in or for said step (A) of providing said primary information data is realized completely or in part by a digital broadcasting service.

In addition or as a further alternative, said step (B) of generating said secondary information data may be performed in one or an arbitrary plurality of circumstances of the group consisting of:
in a stand by mode of said electronic customer device,
in a partial or complete wake-up mode of said given electronic customer device,
at repeated instance of time,
at predetermined instance of time,
at periodical instance of time, and
overnight.

Said step (B) of generating said secondary information data may additionally or alternatively one of being a process or comprising a process of generating an image to be displayed as said display information as or on said start up screen or shut down screen or as a part thereof in accordance with a further embodiment of the method for displaying display information according to the present invention.

Said secondary information data may further additionally or alternatively be or comprise an image to be displayed as said display information as or on said start up screen or shut down screen or as a part thereof in accordance with a preferred embodiment of the method for displaying display information according to the present invention.

As an addition or as an alternative, in the latter two cases said image to be displayed as said display information as or on said start up screen or shut down screen or as a part thereof, one of may be or may be represented or given by or as a bit map file in accordance with a further additional or alternative preferred embodiment of the method for displaying display information according to the present invention.

Said step (B) of generating said secondary information data and therefore the content of said display information and of said image to be displayed may further additionally or alternatively be based on predetermined user profile data which are one of representative or descriptive for user preferences with respect to said display information to be displayed in step (C) in accordance with a further additional or alternative embodiment of the method for displaying display information according to the present invention.

Additionally or alternatively, said step (B) of generating said secondary information data may be performed by involving an existing on screen display engine of said given electronic customer device in accordance with a further embodiment of the method for displaying display information according to the present invention.

Further additionally or alternatively and according to a further advantageous embodiment of the method for displaying display information according to the present invention, said step (B) of generating said secondary information data may be performed using one or an arbitrary plurality of information sources of the group consisting of:
electronic program guide (EPG),
weather,
news,
stocks,
sports results,
messages, in particular email, SMS, MMS,
reminders,
notes,
advertisements,
remote recordings,
what is on TV,
daily tip,
genre tip,
subscription reminders,
customer relationship management,
announcement of firmware updates,
new devices,
archived recordings during night, and
pictures from a user repository.

Consequently, said secondary user information data and in particular a provided image for said display information may additionally or alternative contain one or an arbitrary plurality of the group consisting of:
electronic program guide (EPG),
weather,
news,
stocks,
sports results,
messages, in particular email, SMS, MMS,
reminders,
notes,
advertisements,
remote recordings,
what is on TV,
daily tip,
genre tip,
subscription reminders,
customer relationship management,
announcement of firmware updates,
new devices,
archived recordings during night, and
pictures from a user repository.

As a further alternative or in addition, said secondary information data and in particular said image for said display information may be acoustically enhanced by one of containing or by being accompanied by one or an arbitary plurality of sound, music, and speech, which are to be acoustically presented during step (C) of displaying said display information on said start up screen and/or said shut down screen.

Said secondary information data may further additionally or alternatively be essentially representative for a graphical user interface to be displayed after finalizing a start up and before beginning a shut down of the given electronic customer device.

In said step (C) of displaying said display information on said start up screen said start up screen may be alternatively or additionally be made interactive after finalizing the start up phase of the given electronic customer device. E.g. selection of an information item on an interactive start up screen may lead the user, customer or consumer to further information items which are related to said selected information item.

According to a further aspect of the present invention an apparatus is provided for controlling the display of display information—in particular via a start up screen and/or via a shut down screen of a display means of a customer device—which is adapted and/or arranged and which comprises means for realizing a method for displaying display information according to the present invention.

Additionally, according to a further aspect of the present invention an electronic customer device is provided which is adapted and/or arranged and which comprises means in order to realize or participate in a method for displaying display information according to the present invention—in particular via a start up screen and/or via a shut down screen of a display means of said customer device.

Preferably, the inventive electronic customer device may be one of the group consisting of:
a video recorder, e.g. a PVR having for example a mass storage device, such as a hard disk or an optical disk,
a DVD player,
a DVD recorder,
a TV set or television receiver,
a personal digital assistant,
a digital camera,
a digital broadcast receiver,
a satelite receiver,
a mobile device, e.g. a cell phone,
a pocket computer, and
a personal computer.

Still additionally, according to a further aspect of the present invention a computer program product is provided comprising computer program means which is adapted and/or arranged in order to realize a method for displaying display information according to the present invention—in particular via a start up screen and/or via a shut down screen of a display means of a customer device according—when it is executed on a computer or a digital signal processing means.

According to a further aspect of the present invention a computer readable storage medium is provided comprising a computer program product according to the present invention.

According to another aspect of the present invention a method for generating display information for output to a display device is provided, the display information representing a start up graphic for display during initalisation of software process operating on an electronic user device when in communication with the display device, the method comprising the steps of receiving, at the electronic user device, primary data from an external data source, at least part of the primary data being transferred from the external source in a data push mode; generating, at the electronic user device, secondary data from the primary data, the secondary data including a represetation of at least some of the primary data, the secondary data being processed to generate graphic data; storing the graphic data as a start up graphic; outputting the start up graphic to the display device for display as a start up graphic for one or more software processes; and upon initialisation of at least some of the software processes operating on the electronic user device, regenerating the start up graphic from the secondary data as a Graphical User Interface for the electronic user device such that the start up graphic is segmented into a number of regions, at least one region being assigned to a software process, the at least one region being selectable by a user to provide at least one input to the assigned software process operating on the electronic user device.

According to a further aspect of the present invention a system for generating display information for output to a display device is provided, the display information representing a start up graphic for display during initalisation of software process operating on an electronic user device when in communication with the display device, the system comprising means for receiving, at the electronic user device, primary data from an external data source, at least part of the primary data being transferred from the external source in a data push mode; means for generating, at the electronic user device, secondary data from the primary data, the secondary data including a represetation of at least some of the primary data, the secondary data being processed to generate graphic data; means for storing the graphic data as a start up graphic; means for outputting the start up graphic to the display device for display as a start up graphic for one or more software processes; and means for—upon initialisation of at least some of the software processes operating on the electronic user device—regenerating the start up graphic from the secondary data as a Graphical User Interface for the electronic user device such that the start up graphic is segmented into a number of regions, at least one region being assigned to a software process, the at least one region being selectable by a user to provide at least one input to the assigned software process operating on the electronic user device.

According to still a further aspect of the present invention an electronic user device for generating display information for output to a display device is provided, the display information representing a start up graphic for display during initalisation of software process operating on said electronic user device when in communication with the display device, the electronic user device comprising means for receiving, at the electronic user device, primary data from an external data source, at least part of the primary data being transferred from the external source in a data push mode; means for generating, at the electronic user device, secondary data from the primary data, the secondary data including a represetation of at least some of the primary data, the secondary data being processed to generate graphic data; means for storing the graphic data as a start up graphic; means for outputting the start up graphic to the display device for display as a start up graphic for one or more software processes; and means for—upon initialisation of at least some of the software processes operating on the electronic user device—regenerating the start up graphic from the secondary data as a Graphical User Interface for the electronic user device such that the start up graphic is segmented into a number of regions, at least one region being assigned to a software process, the at least one region being selectable by a user to provide at least one input to the assigned software process operating on the electronic user device.

These and further aspects of the present invention will be further discussed in the following:

The present invention inter alia relates to a dynamic start up screen.

Most people are aware of common and non-informative boot up screens presented during the initialization phase of PC and CE devices. These screens are presented to show that the device is in some way active but yet not ready to fulfill its functions. Because of the need for error display the graphics hardware is always booted up at a very early stage and is therefore able to present the start up screen during the rest of the hardware is booted. The image for the start up screen is stored in a permanent memory preferably in flash memory to be accessed before external medias are booted.

To avoid these non-informative start up screens a technique is proposed where valuable information is downloaded preferably during standby time and an image is rendered using the standard OSD engine according to user preferences.

Known start up screens are static to avoid consuming processing power, they are used to identify model brand and software versions and they are mainly bitmaps which can be easily displayed by the graphics chipset.

The following one or an arbitrary plurality of aspects can be realized according to the present invention:
The use of the power up time of the different hardware components to display valuable information.
The information has to be compiled before the device is started.
The information has different sources.
The start up screen is preferably user customizable.
The start up screen uses preferably the implemented OSD or on screen display engine to render the image for the start up screen.

Additionally or alternatively, the following one or an arbitrary plurality of aspects can be realized according to the present invention:
The start up screen is an image which can be easily displayed after graphics chipset is powered up.
The start up screen is preferably stored in flash memory.
The start up screen is displayed for a reasonable time at least as long as the different hardware components need to power up.
The start up screen is compiled after downloading service information.
The downloading of service information is preferably done during a wakeup cycle in the standby mode of the device.
The wakeup cycle does not necessarily power up all hardware chipsets.
Devices are TV-sets, set top boxes, recorders, streaming devices, PC and mobile devices.
The information displayed in the start up screen is extracted from a broadcasting stream or an internet connection or a local area network or local storage of the device.
There is no need for a bi-directional communication in case of broadcasting devices.
The information provided to the device could be related to a user profile stored on a server.
The information extracted by the device could by filtered according to a user profile stored on the device.
The information extracted by the device could by filtered according to a device address stored in the device.
The sources for information could be an EPG or other data service which could be downloaded in the night.
Every information source is displayed in a separate field of the start up screen.
The start up screen contains at least one field.
The size and position of the fields are preferably customizable by user and/or service provider.
The information displayed in the fields is preferably customizable in respect to the content source and selection criteria.
The start up screen is not interactive during boot up time.
The start up screen is preferably becoming interactive after boot up.
The start up screen is preferably rendered using the OSD display or on screen display engine of the device.
Content sources are: EPG, Weather, News, Stocks, Sport results, Messages (email, SMS, MMS), Reminders, Notes, Advertisements, Remote Recordings, What's on TV, Daily Tip, Genre Tip, Subscription reminders, customer relationship management, announcement of firmware updates or new devices, archived recordings during the night, pictures from a user repository.
As an enhancement music or voice messages could be presented during boot up screen display.
As an enhancement the boot screen could be animated.
The boot up screen could also be displayed as a screen saver, e.g. suitable for plasma displays.
The start up screen could also be displayed after power down was initiated by the user, e.g. display sponsorship banner.

According to the present invention the start up time can be used to provide valuable information and to reduce the subjective waiting time. Additional revenue schemes for TV channels, device manufacturers and service providers can be implemented.

The invention will now be explained based on preferred embodiments thereof and by taking reference to the accompanying and schematic figures.

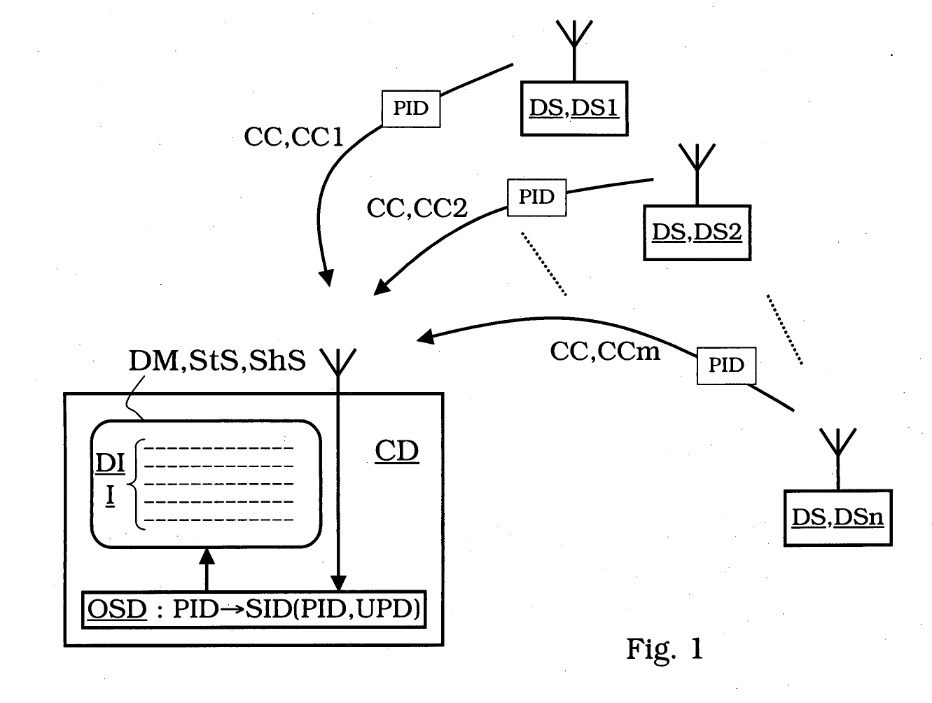

FIG. 1 is a schematic block diagram which shows an arrangement to which an embodiment of a method for displaying display information according to the present invention can be applied.

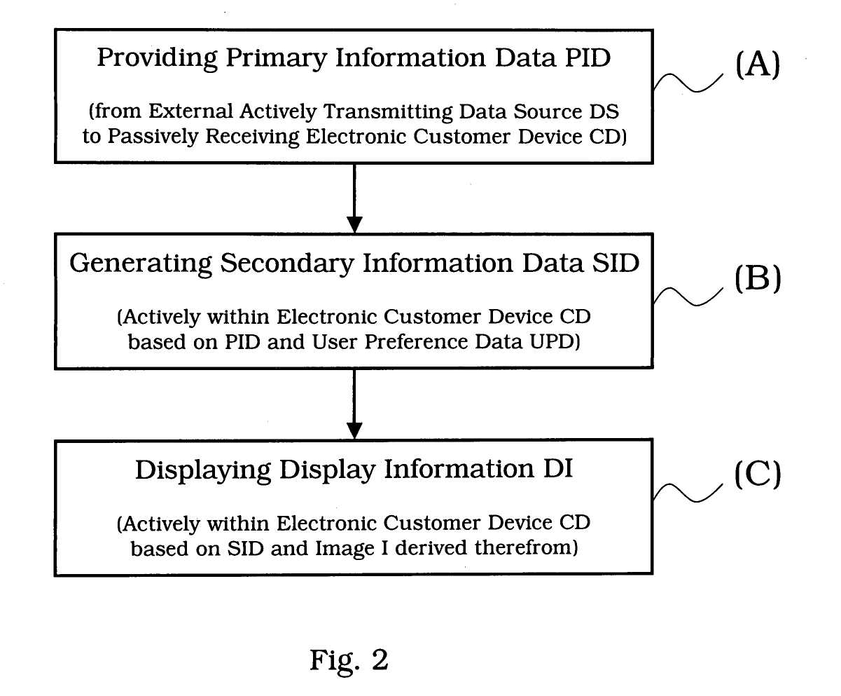

FIG. 2 is schematic flow chart illustrating an embodiment of a method for displaying display information according to the present invention.

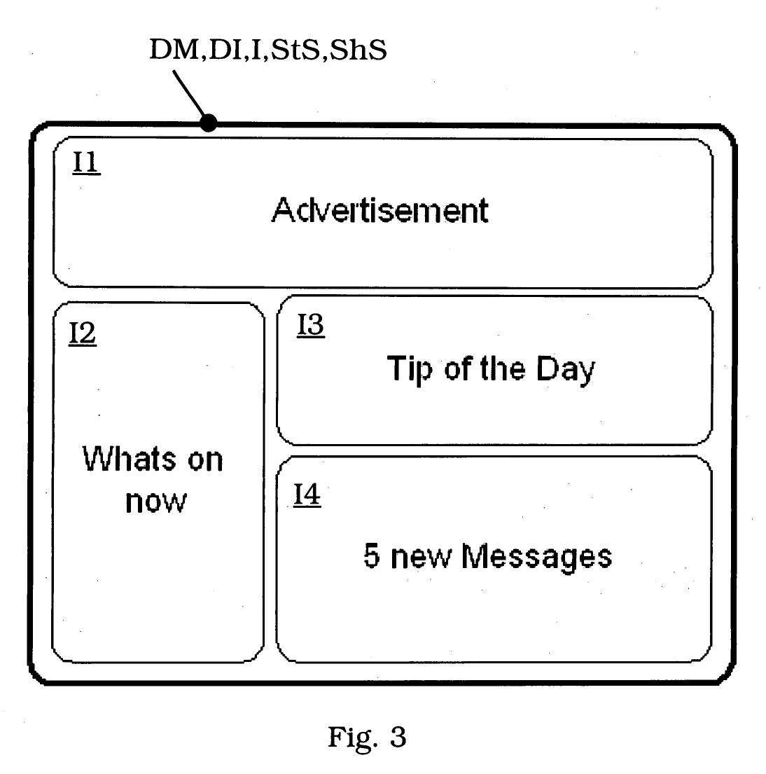

FIG. 3 is a schematic block diagram which demonstrates a display situation according to a preferred embodiment of a method for displaying display information according to the present invention.

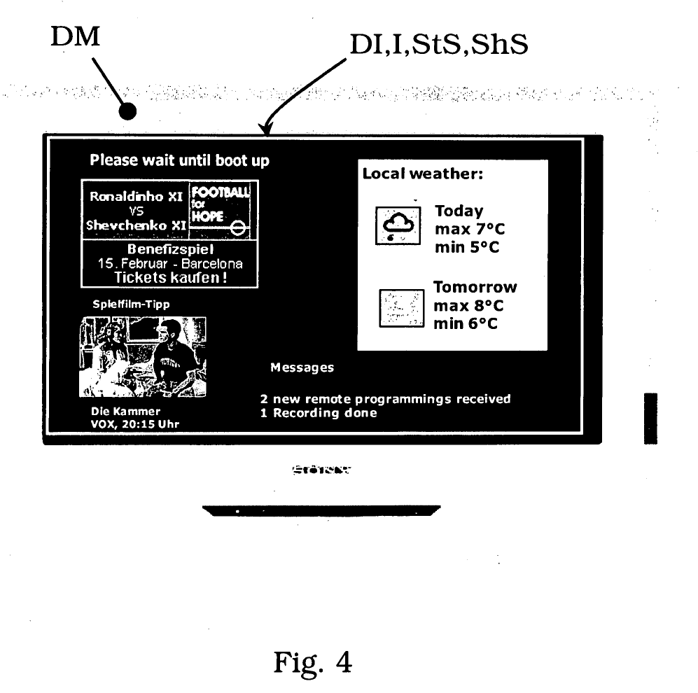

FIG. 4 is a schematic block diagram which demonstrates a display situation according to a further preferred embodiment of a method for displaying display information according to the present invention.

In the following functional and structural similar or equivalent element structures will be denoted with the same reference symbols. Not in each case of their occurrence a detailed description will be repeated.

FIG. 1 is a schematic block diagram which shows an arrangement to which an embodiment of a method for displaying display information DI according to the present invention can be applied.

The arrangement of FIG. 1 consists of an electronic customer device CD having display means DM for displaying display information DI which is given by an image I and of a plurality or variety of different or comparable data sources DS, DS1, . . . , DSm which may be connected to said electronic customer device CD via a plurality or a variety of different or comparable communication channels CC, CC1, . . . , CCn. The display information DI to be displayed on said display means DM is based on secondary information data SID which are derived from primary information data PID within said electronic customer device CD in an active manner by using a so called on screen display engine or OSD engine OSD contained therein. Said primary information data PID are received in a passive manner by said electronic customer device CD. The generation of said secondary information data SID of therefore of said display information DI and consequently of said image I to be displayed on said display means DM as a start up screen StS or as a shut down screen ShS is based on user preference data UPD being descriptive for the information content and display style preferred by a user of said electronic customer device CD. There may exist a variety of different or comparable communication channels CC, CC1, . . . , CCn to one or to a variety of different or comparable data sources DS, DS1, . . . , DSm.

FIG. 2 is schematic flow chart illustrating an embodiment of a method for displaying display information according to the present invention.

According to a first step (A) primary information data PID are provided. This is done by actively transmitting said primary information data PID by and from a data source DS to a passively receiving electronic customer device CD.

In a following step (B) secondary information data SID are generated from said primary information data PID. This is done actively within said electronic customer device CD in an active manner by taking into account user preference data UPD which might be learned and/or which might be obtained from some data base. Thereby, said display information DI or a corresponding image I might be derived.

In a following step (C) said display information DI or a corresponding image are actively displayed on display means DM of said electronic customer device CD during a start up and/or during a shut down phase of said electronic customer device CD.

FIG. 3 is a schematic block diagram which demonstrates a display situation according to a preferred embodiment of a method for displaying display information DI according to the present invention. On a display means DM of an electronic customer device CD an image I corresponding to display information DI to display as or on an start up screen StS or shut down screen ShS is formed as a superposition of partial images I1 to I4 corresponding to different information contents, e.g. advertisement, what is on TV, tip of the day, and new messages.

FIG. 4 is a schematic but more illustrative block diagram which demonstrates a display situation according to a further preferred embodiment of a method for displaying display information DI according to the present invention. Again, on a display means DM of an electronic customer device CD an image I corresponding to display information DI to display as or on an start up screen StS or shut down screen ShS is formed as a superposition of certain partial images corresponding to different information contents.

### REFERENCE SYMBOLS

CC Communication channel
CC1, . . . , CCm Communication channel
CD Electronic customer device
DI Display information
DM Display means
DS Data source
DS1, . . . , DSn Data source
I image
I1, . . . , I4 Partial image
PID Primary information data
SID Secondary information data
ShS Shut down screen
StS Start up screen
UPD User preference data

1. A method for displaying display information (DI), via a start up screen (StS) and/or via a shut down screen (ShS) of a display of an electronic customer device (CD), comprising steps of:
providing primary information data (PID),
generating from said primary information data (PID) secondary information data (SID) which are one of descriptive and representative for said display information (DI) to be displayed, and
displaying on a start up screen (StS) and/or on a shut down screen (ShS) at least said display information (DI) as said secondary information data (SID) or as a derivative thereof,
wherein said providing said primary information data (PID) is realized by at least passively receiving said primary information data (PID) by said electronic customer device (CD) from a data source (DS) external to said electronic customer device (CD) and said generating said secondary information data (SID) and said display information (DI) is actively realized within said electronic customer device (CD).

2. The method according to claim 1, wherein said providing said primary information data (PID) is realized by actively transmitting or pushing said primary information data (PID) from said data source (DS) to said electronic customer device (CD).

3. The method according to claim 1, wherein an uni-directional communication channel (CC) is used in or for said providing said primary information data (PID).

4. The method according to claim 1, wherein said providing said primary information data (PID) is performed in one or an arbitrary plurality of circumstances of the group consisting of:
in a stand by mode of said electronic customer device (CD),
in a partial or complete wake up mode of said electronic customer device (CD),
at repeated instances of time,
at predetermined instances of time,
at periodical instances of time, and
overnight.

5. The method according to claim 1, wherein said communication channel (CC) in or for said providing said primary information data (PID) is realized completely or in part by one or an arbitrary plurality of circumstances of the group consisting of:
terrestrially,
via cable,
via air or wirelessly,
via satellite,
via a network,
via a home network, and
via the internet.

6. The method according to claim 1, wherein said generating said secondary information data (SID) is performed in one or arbitrary plurality of circumstances of the group consisting of:
in a stand by mode of said electronic customer device (CD),
in a partial or complete wake-up mode of said given electronic customer device (CD),
at repeated instance of time,
at predetermined instance of time,
at periodical instance of time, and
overnight.

7. The method according to claim 1, wherein said generating said secondary information data (SID) one of is or comprises a process of generating an image (I) to be displayed as said display information (DI) as at least a part of said start up screen (StS) or shut down screen (ShS).

8. The method according to claim 1, wherein said secondary information data (SID) is or comprises an image (I) to be displayed as said display information (DI) as said or on said start up screen (StS) or shut down screen (ShS) or as a part thereof.

9. The method according to claim 8, wherein said image (I) to be displayed as said display information (DI) is or is represented by a bit map file.

10. The method according to claim 1, wherein said generating said secondary information data (SID) and therefore the content of said display information (DI) and of said image (I) to be displayed are based on predetermined user profile data (UPD) which are one of representative or descriptive for user preferences with respect to said display information (DI) to be displayed in step (C).

11. The method according to claim 1, wherein said generating said secondary information data (SID) is performed by involving an existing on-screen display engine (OSD) of said electronic customer device (CD).

12. The method according to claim 1, wherein said generating said secondary information data (SID) is performed using one or an arbitrary plurality of information sources of the group consisting of:
electronic program guide or EPG,
weather,
news,
stocks,
sports results,
messages, email, SMS, MMS,
reminders,
notes,
advertisements,
remote recordings,
what is on TV,
daily tip,
genre tip,
subscription reminders,
customer relationship management,
announcement of firmware updates,
new devices,
archived recordings during night, and
pictures from a user repository.

13. The method according to claim 1, wherein said secondary user information data (SID) and a provided image (I) for said display information (DI) contains one or an arbitrary plurality of the group consisting of:
electronic program guide (EPG),
weather,
news,
stocks,
sports results,
messages, email, SMS, MMS,
reminders,
notes,
advertisements,
remote recordings,
what is on TV,
daily tip,
genre tip,
subscription reminders,
customer relationship management,
announcement of firmware updates,
new devices,
archived recordings during night, and
pictures from a user repository.

14. The method according to claim 13, wherein said secondary information data (SID) and said image (I) for said display information (DI) are acoustically enhanced by one of containing or by being accompanied by one or an arbitrary plurality of sound, music, and speech, which are to be acoustically presented during displaying said display information (DI) on said start up screen (StS) and/or said shut down screen (ShS).

15. The method according to claim 1, wherein said secondary information data (SID) is at least in part representative for a graphical user interface (GUI) to be displayed after finalizing a start up and before beginning a shut down of the given electronic customer device (CD).

16. The method according to claim 1, wherein in said displaying said display information (DI) on said start up screen (StS) said start up screen (StS) is made interactive after finalizing the start up phase of the given electronic customer device (CD).

17. Apparatus for controlling the display of display information (DI) via a start up screen (StS) and/or via a shut down screen (ShS) of a display of a customer device (CD), which is operable and which comprises means for realizing the method for displaying display information (DI) according to claim 1 and the steps thereof.

18. Electronic customer device (CD),
which is adapted and/or arranged and which comprises means in order to realize or participate in a method for displaying display information (DI) via a start up screen (StS) and/or via a shut down screen (ShS) of a display of said customer device (CD) according to claim 1 and the steps thereof.

19. Electronic customer device (CD) according to claim 18, which is one of the group consisting of:
a video recorder,
a DVD player,
a DVD recorder,
a TV set or a television receiver,
a personal digital assistant,
a digital camera,
a digital broadcast receiver,
a satelite receiver,
a mobile device, e.g. a cell phone,
a pocket computer, and
a personal computer.

20. Computer program product,
comprising computer program means which is adapted and/or arranged in order to realize a method for displaying display information (DI) via a start up screen (StS) and/or via a shut down screen (ShS) of a display of a customer device (CD) according to claim 1 when it is executed on a computer or a digital signal processing means.

21. Computer readable storage medium,
comprising a computer program product according to claim 20.

22. The method for generating display information for output to a display device, the display information representing a start up graphic for display during initialization of software process operating on an electronic user device when in communication with the display device, the method comprising the steps of:
receiving, at the electronic user device, primary data from an external data source, at least part of the primary data being transferred from the external source in a data push mode;
generating, at the electronic user device, secondary data from the primary data, the secondary data including a representation of at least some of the primary data, the secondary data being processed to generate graphic data;
storing the graphic data as a start up graphic;
outputting the start up graphic to the display device for display as a start up graphic for one or more software processes; and
upon initialization of at least some of the software processes operating on the electronic user device, regenerating the start up graphic from the secondary data as a Graphical User Interface for the electronic user device such that the start up graphic is segmented into a number of regions, at least one region being assigned to a software process, the at least one region being selectable by a user to provide at least one input to the assigned software process operating on the electronic user device.

23. System for generating display information for output to a display device, the display information representing a start up graphic for display during initialization of software process operating on an electronic user device when in communication with the display device, the system comprising:
means for receiving, at the electronic user device, primary data from an external data source, at least part of the primary data being transferred from the external source in a data push mode;
means for generating, at the electronic user device, secondary data from the primary data, the secondary data including a representation of at least some of the primary data, the secondary data being processed to generate graphic data;
means for storing the graphic data as a start up graphic;
means for outputting the start up graphic to the display device for display as a start up graphic for one or more software processes; and
means for—upon initialization of at least some of the software processes operating on the electronic user device—regenerating the start up graphic from the secondary data as a Graphical User Interface for the electronic user device such that the start up graphic is segmented into a number of regions, at least one region being assigned to a software process, the at least one region being selectable by a user to provide at least one input to the assigned software process operating on the electronic user device.

24. Electronic user device adapted for generating display information for output to a display device, the display information representing a start up graphic for display during initialization of software process operating on said electronic user device when in communication with the display device, the apparatus comprising:
means for receiving, at the electronic user device, primary data from an external data source, at least part of the primary data being transferred from the external source in a data push mode;
means for generating, at the electronic user device, secondary data from the primary data, the secondary data including a representation of at least some of the primary data, the secondary data being processed to generate graphic data;
means for storing the graphic data as a start up graphic;
means for outputting the start up graphic to the display device for display as a start up graphic for one or more software processes; and
means for—upon initialization of at least some of the software processes operating on the electronic user device—regenerating the start up graphic from the secondary data as a Graphical User Interface for the electronic user device such that the start up graphic is segmented into a number of regions, at least one region being assigned to a software process, the at least one region being selectable by a user to provide at least one input to the assigned software process operating on the electronic user device.
